(19) United States
(12) Patent Application Publication
(10) Pub. No.: US 2025/0135436 A1
(43) Pub. Date: May 1, 2025

(54) SORBENT MATERIAL FOR CO2 CAPTURE, USES THEREOF AND METHODS FOR MAKING SAME

(71) Applicant: CLIMEWORK AG, Zürich (CH)

(72) Inventors: Angelo VARGAS, Zürich (CH); David ALBANI, Zürich (CH); Nina-Luisa MICHELS, Zürich (CH); Tomas AZTIRIA, Zürich (CH); Kim Maureen TRÖSCH, Zürich (CH); Gerald BAUER, Zürich (CH)

(73) Assignee: CLIMEWORK AG, Zürich (CH)

(21) Appl. No.: 18/710,101

(22) PCT Filed: Nov. 22, 2022
(86) PCT No.: PCT/EP2022/082826

§ 371 Date: May 14, 2024

(30) Foreign Application Priority Data
Nov. 25, 2021 (EP) 21210541.5

(51) Int. Cl. B01J 20/26; B01D 53/62; B01D 53/82; B01D 53/96; B01J 20/28; B01J 20/30; B01J 20/34

(52) U.S. Cl. CPC B01J 20/262; B01D 53/62; B01D 53/82; B01D 53/96; B01J 20/267; B01J 20/28004; B01J 20/28019; B01J 20/28059; B01J 20/28061; B01J 20/28064; B01J 20/28066; B01J 20/3071; B01J 20/3085; B01J 20/3425; B01J 20/3466; B01D 2253/202; B01D 2253/304; B01D 2253/306; B01D 2253/34; B01D 2257/504; B01D 2258/0283; B01D 2258/05; B01D 2258/06; B01D 2259/4009

(57) ABSTRACT

Method for the preparation of sorbent material for use as adsorbent for carbon dioxide separation from a gas mixture, the sorbent material having primary amine or secondary amine moieties, or a combination thereof, immobilised on a solid support, wherein the sorbent material has primary amine or secondary amine moieties, or a combination thereof, is treated so as to have, after treatment, a total metal impurity content below 1400 ppm.

### TECHNICAL FIELD

The present invention relates to carbon dioxide capture materials with primary and/or secondary amine carbon dioxide capture moieties with optimum carbon dioxide capture capacity properties, as well as methods for preparing such capture materials, uses of such capture materials and carbon dioxide capture methods involving such materials and renewal processes for such capture materials.

### PRIOR ART

According to the OECD report of 2017 [Global Energy & CO₂ Status Report 2017, OECD/IEA March 2018] the yearly emissions of CO₂ to the atmosphere are ca 32.5 Gt (Gigatons, or 3×109 tons). As of February 2020 all but two of the 196 states that in 2016 have negotiated the Paris Agreement within the United Nations Framework Convention on Climate Change (UFCCC) have ratified it. The meaning of this figure is that a consensus is reached regarding the threat of climate change and regarding the need of a global response to keep the rise of global temperature well below 2 degrees Celsius above pre-industrial levels.

The technical and scientific community engaged in the challenge of proposing solutions to meet the target of limiting CO₂ emissions to the atmosphere and to remove greenhouse gases from the atmosphere has envisioned a number of technologies. Flue gas capture, or the capture of CO₂ from point sources, such as specific industrial processes and specific CO₂ emitters, deals with a wide range of relatively high concentrations of CO₂ (3-100 vol %) depending on the process that produces the flue gas. High concentrations make the separation of the CO₂ from other gases thermodynamically more favorable and consequently economically favorable as compared to the separation of CO₂ from sources with lower concentrations, such as ambient air, where the concentration is in the order of 400 ppmv. Nonetheless, the very concept of capturing CO₂ from point sources has strong limitations: it is specifically suitable to target such point sources, but is inherently linked to specific locations where the point sources are located and can at best limit emissions and support reaching carbon neutrality, while as a technical solution it will not be able to contribute to negative emissions (i.e., permanent removal of carbon dioxide from the atmosphere) and to remove emission from the past. In order to achieve negative emissions (i.e., permanent removal carbon dioxide from the atmosphere), the two most notable solutions currently applied, albeit being at an early stage of development, are the capturing of CO₂ by means of vegetation (i.e., trees and plants, but not really permanent removal) using natural photosynthesis, and by means of DAC technologies, which is the only really permanent removal.

Forestation has broad resonance with the public opinion. However, the scope and feasibility of re-forestation projects is debated and is likely to be less simple an approach as believed because it requires a large footprint in terms of occupied surface to captured CO₂ ratio. On the other hand, DAC has lower land footprint and therefore it does not compete with the production of crops, can permanently remove CO₂ from the atmosphere and can be deployed everywhere on the planet.

The above-described strategies to mitigate climate change all have potential and are considered as a potential part of the overall solution. The most likely future scenario is the deployment of a mix of such approaches, after undergoing further development.

Several DAC technologies were described, such as for example, the utilization of alkaline earth oxides to form calcium carbonate as described in US-A-2010034724. Different approaches comprise the utilization of solid CO₂ adsorbents, hereafter named sorbents, in the form of packed beds of typically sorbent particles and where CO₂ is captured at the gas-solid interface. Such sorbents can contain different types of amino functionalization and polymers, such as immobilized aminosilane-based sorbents as reported in U.S. Pat. No. 8,834,822, and amine-functionalized cellulose as disclosed in WO-A-2012/168346.

WO-A-2011/049759 describes the utilization of an ion exchange material comprising an aminoalkylated bead polymer for the removal of carbon dioxide from industrial applications. WO-A-2016/037668 describes a sorbent for reversibly adsorbing CO₂ from a gas mixture, where the sorbent is composed of a polymeric adsorbent having a primary amino functionality. The materials can be regenerated by applying pressure or humidity swing. Several academic publications, such as Alesi et al. in Industrial & Engineering Chemistry Research 2012, 51, 6907-6915; Veneman et al. in Energy Procedia 2014, 63, 2336; Yu et al. in Industrial & Engineering Chemistry Research 2017, 56, 3259-3269, also investigated in detail the use of cross-linked polystyrene resins functionalized with primary benzyl-amines as solid sorbents for DAC applications.

The state-of-the-art technology to capture CO₂ from point sources typically uses liquid amines, as for example in industrial scrubbers, where the flue gas flows into a solution of an amine (U.S. Pat. No. 9,186,617). Other technologies are based on the use of solid sorbents in either a pack-bed or a flow-through structure configuration, where the sorbent is made of impregnated or covalently bound amines onto a support.

Amines react with CO₂ to form of a carbamate moiety, which in a successive step can be regenerated to the original amine, for example by increasing the temperature of the sorbent bed to ca 100° C. and therefore releasing the CO₂. An economically viable process for carbon capture implies the ability to perform the cyclic adsorption/desorption of CO₂ for hundreds or thousands of cycles over the same sorbent material, where the sorbent shall not undergo significant chemical transformations that impedes its reactivity towards CO₂.

Maketon et al. in “Removal Efficiency and Binding Mechanisms of Copper and Copper-EDTA Complexes Using Polyethyleneimine”, ENVIRONMENTAL SCIENCE & TECHNOLOGY, vol. 42, no. 6, 8 Feb. 2008, pages 2124-2129, report that copper is used extensively in semiconductor circuits as the multilayer metal. In addition to copper, waste streams often contain chelating agents like EDTA, which is widely used in the process to enhance solubility of copper, and it tends to form copper-chelated complexes. PEI-agarose adsorbents in a packed-bed column are capable of removing these anionic complexes, but the competitive binding between this chelating agent and PEI for copper is not well understood. The presented work focuses on investigating copper sorption by PEI-agarose adsorbent in the presence of EDTA. The pH of the column is fixed at 5.5 using 0.1 M acetate buffer. The ratio of chelator to copper ions is varied. Copper binding capacity and copper breakthrough curves are compared and contrasted to results without additional chelator present. An excess of EDTA leads to an increase in the fraction of free dissociated (anionic) ligand that competes for electrostatic attraction on protonated amine groups and therefore leads to a decrease in sorption capacity in the column. However, this waste treatment technique is still feasible for the semiconductor industry as large volumes of copper-contaminated solutions from actual waste can be concentrated 12-fold. When equimolar (copper to EDTA) or higher concentrations of EDTA are present, acetate can be utilized to recover the metal; for low ratios of copper to EDTA, metal recovery is achieved using hydrochloric acid.

US-A-2012076711 discloses a structure containing a sorbent with amine groups that is capable of a reversible adsorption and desorption cycle for capturing CO₂ from a gas mixture wherein said structure is composed of fiber filaments wherein the fiber material is carbon and/or polyacrylonitrile.

US-A-2013213229 discloses an acid-gas sorbent comprising an amine-composite. The composite may comprise a first component comprising an amine compound at a concentration of from about 1 wt % to about 75 wt %; a second component comprising a hydrophilic polymer and/or a pre-polymer compound at a concentration of from about 1 wt % to about 30 wt %; and a third component comprising a cross-linking agent, and/or a coupling agent at a concentration of from about 0.01 wt % to about 30 wt %.

US-A-2019143299 discloses a core-shell type amine-based carbon dioxide adsorbent including a chelating agent resistant to oxygen and sulfur dioxide as an adsorbent which includes a chelating agent to inhibit oxidative decomposition of amine and has, as a core, a porous support on which an amine compound is immobilized and has, as a shell, an amine layer resistant to inactivity by sulfur dioxide, and a method of preparing the same. The amine-based carbon dioxide adsorbent including a chelating agent exhibits considerably high oxidation resistance because an added chelate compound functions to directly remove a variety of transition metal impurities catalytically acting on amine oxidation. In addition, the sulfur dioxide-resistant amine layer of the shell selectively adsorbs sulfur dioxide to protect the amine compound of the core and, at the same time, the amine compound of the core selectively adsorbs only carbon dioxide. In addition, sulfur dioxide adsorbed on the shell is readily desorbed therefrom at about 110° C. and thus remarkably improved regeneration stability is obtained during the temperature-swing adsorption (TSA) process containing sulfur dioxide.

### SUMMARY OF THE INVENTION

Amino-based sorbents for cyclic continuous carbon dioxide capture from air, in particular amino-based sorbents containing primary and/or secondary amino units, preferably benzylamine units, or combinations thereof, connected for example to styrene divinylbenzene moieties, are known sorbents for carbon capture from the air and from flue gas.

In the present invention, surprisingly we have identified that the CO₂ capture performance (carbon dioxide capture capacity) of these materials can vary, notwithstanding the overall nitrogen content (an indication of the total amino content) is not changing significantly. By carrying inductively couple plasma optical emission spectroscopy (hereafter referred as ICP-OES) analysis we have identified with great surprise that the overall metal content correlates with the CO₂ capture performance, see FIG. 1.

Without being bound to any theoretical explanation, it seems that to be especially apt for carbon capture, amino-based sorbents need to have a little as possible impurities that could bind to the amino group and/or block pores that would then reduce the accessibilities of the amino site with consequences on the carbon dioxide capture performance. Therefore, competitive binding to the amino groups competing with the carbon dioxide capture is to be avoided. It was found that the amino moieties provided for carbon dioxide capture can and actually will bind to a wide range of metals, and such binding impairs the carbon dioxide capture capacity of the material. Reducing the metal content of the sorbent material unexpectedly provides for a very efficient simple way to increase the carbon dioxide capture properties of the material. In fact, the amino-based sorbent materials are typically produced using catalysts and involving washing steps, and in the steps apparently a significant number of the surface exposed amino groups are capped by metal ions from the catalysis and/or washing, from starting materials or other synthetic steps.

The present invention correspondingly relates to the purity level that an amino-based sorbent functionalized with primary or secondary amine, or a combination thereof, requires to have all amino groups able to efficiently capture CO₂. The present invention also relates to methods to remove impurities and reach a purity level acceptable for carbon capture. The proposed methods can be used for preparing sorbent materials for a carbon dioxide capture process, but it can also be used for refreshing sorbent materials after having been used as carbon dioxide capture materials. In particular the latter is important if the water, vapour and/or steam is used in the desorption process desorbing the carbon dioxide from the sorbent material, and if in that water, vapour and/or steam metal impurities are successively accumulated in the sorbent material deteriorating its carbon dioxide capture capacity.

As evidenced further below, the metal content or impurity content of the material not only affects the initial carbon dioxide capture capacity of the material. It also affects the stability of the carbon dioxide capacity after aging, which means over extended time of use. It was surprisingly found out that material which has been purified and which has a low metal content also shows higher stability of the carbon dioxide capture capacity, i.e. it appears to be less prone to degradation, likely less prone to oxidation during use. 20 In one embodiment, the amount of metals of a sorbent material comprising primary and/or secondary benzylamine moieties or a combination thereof, preferably the carbon dioxide capture moieties of the sorbent material consist of primary benzylamine moieties, is in the range 5-1600 ppm, most preferably below 1500 ppm. The ppm values given here for the metal content are in each case given in ppm by weight. The solid support of the sorbent material is preferably a porous or non-porous material based on an organic and/or inorganic material, preferably a (organic) polymer material. A (organic) polymer carrier material is preferably selected from the group of linear or branched, cross-linked or uncross-linked polystyrene, polyethylene, polypropylene, polyamide, polyurethane, acrylate-based polymer including PMMA, polyacrylonitrile or combinations thereof, wherein preferably the polymer material is poly(styrene) or poly(styrene-co-divinylbenzene) based, cellulose, or an inorganic material including silica, alumina, activated carbon, metal organic frameworks, covalent organic frameworks and combinations thereof.

In another embodiment, a sorbent comprising polyethyleneimine either physically impregnated or chemically bound to the surface of a support, where the support can be but not limited to silica, alumina, zeolites, activated carbons, metal organic framework, covalent organic framework, presents an impurity level in the range 5-2000 ppm, most preferably below 1500 ppm to be able to have most or all amino sites available to capture carbon dioxide.

In another embodiment, to remove the metals (or rather metal ions) and thus repristinating the CO₂ capture performance, sorbents are treated with an acid, which can be HCl, HNO₃, H₂SO₄, CH₃COOH, in concentration from 0.01-10 mol/L or 0.25 to 10 mol/L. The sorbent can be kept reacting with the acid solution under stirring for 1 up to 24 h. Subsequently to deprotonate the amino group and thus having the amine as a free base, the sorbent is preferably treated with a base, which can be NaOH, Na₂CO₃, KOH, or a combination thereof. This treatment is hereafter referred as acid base wash, keeping in mind that the base treatment can be replaced by an extended washing treatment with essentially neutral and/or demineralized water. After the treatment the capacity of the purified sorbent can be measured in a breakthrough analyzer and the results thereof for the worked systems are presented in FIG. 2. Surprisingly, the carbon dioxide capture capacity increased by a factor of up to 2.8.

In another embodiment, another treatment is described for purifying the sorbent and increasing the CO₂ capacity of the sorbent. The treatment comprises washing with an eluotropic row sequence, which comprises or consists of treating the sorbent with various solvents from high to low polarity by conducting at least 2 or at least 3 consecutive washing steps with 2 or 3 solvents of differing polarity. The first solvent can be methanol, ethanol, isopropanol, or a combination thereof the second solvent can be acetone or another ketone with up to 10 carbon atoms, and the third solvent can be hexane, heptane, octane, dodecane. Unexpectedly, the CO₂ capture capacity of the benzylamine-based sorbent is increased by a factor of 2.54 following the eluotropic row treatment (FIG. 2).

In another embodiment, styrene-divinylbenzene resin functionalized with benzylamine is treated with a chelating agent, in particular ethylenediaminetetraacetic acid (EDTA), is used for removing the metal impurities. Here the CO₂ capture capacity of the sorbent increased by a factor of 2.8 (FIG. 2).

In another embodiment, the acid and base wash, the eluotropic row and the wash with EDTA are carried out in various combinations, performing multiple (2 to 5) acid base washes consecutively, and doing first and acid base wash followed by an eluotropic row or vice versa, and doing first acid and base wash followed by a washing step with EDTA or vice versa, and an eluotropic row treatment followed by a washing with EDTA or vice versa. FIG. 2 shows the effect of 3 consecutive acid base washes, resulting in an increase in the CO₂ capture capacity by a factor of 3.2.

In more general terms, according to first aspect of the present invention, it relates to a method for the preparation of sorbent material for use as adsorbent for carbon dioxide separation from a gas mixture, said sorbent material comprising primary amine or secondary amine moieties, or a combination thereof, immobilised on a solid support. According to this first aspect, said sorbent material comprising primary amine or secondary amine moieties, or a combination thereof, is treated so as to have, after treatment, a total metal impurity content below 1400 ppm. As pointed out above, pristine amine-based capture materials due to production processes inherently comprise a large number of surface exposed amino moieties which are capped with metal ions, according to our analysis the metal impurity content in the systems is always above or around 1600 ppm. Only an additional treatment provides for a lower metal impurity content as claimed and correspondingly provides for significantly increased carbon dioxide capture capacity.

When talking about a method for the preparation of sorbent material for use as adsorbent for carbon dioxide separation from a gas mixture, this means a treatment of sorbent material for preparing it and/or for repristinating/refreshing and/or for cleaning and optimizing it for use as adsorbent for carbon dioxide separation from a gas mixture. The term preparation is thus understood as the physical and/or chemical transformation of the sorbent material to convert it into a sorbent material into one having a lower metal impurity content, in particular a total metal impurity content below 1400 ppm. The proposed method comprises at least one step of converting it into such a purified sorbent material to make it (more) suitable as an adsorbent for carbon dioxide separation from a gas mixture, this step can be structured and carried out as detailed further below.

The proposed method put differently thus is a method in which a starting sorbent material is treated in a purification step to have, after treatment, the claimed lower metal impurity content in particular to make it (more) suitable as a sorbent material for use as adsorbent for carbon dioxide separation from a gas mixture.

It is noted that one possible structuring of a process for carbon dioxide separation from a gas mixture comprises a step of inducing an increase of the temperature of the sorbent material, e.g. to a temperature between 6° and 110° C., starting the desorption of CO2, and this is done by injecting a stream of saturated or superheated steam by flow-through through a unit and thereby inducing an increase of the temperature of the sorbent material to a temperature between 6° and 110° C., starting the desorption of CO2. As will be shown experimentally further below, such a steam treatment does not lead to a reduction of the metal impurity content at all, in fact, simple water washing treatment or steam treatment does not influence the metal impurity content and also not the CO₂ capture capacity in a beneficial way.

According to a first preferred embodiment of this first aspect, said sorbent material, after treatment, has a total metal impurity content below 1200 ppm, preferably below 1100 ppm, most preferably in the range of 200-1000 ppm. Purifying the sorbent material to these low metal impurity degrees allows to increase the carbon dioxide capture capacity up to a factor of 3, which is fully unexpected and an extremely significant increase of efficiency of the overall process.

The total metal impurity content as defined here is to be considered as the sum of all metal in the sorbent material by weight, relative to the total sorbent material weight, and metals are defined as elements from the groups 1-16 of the periodic table, in group 1 with the exception of hydrogen, in group 13 with the exception of beryllium, in group 14 with the exception of the elements of periods 2-4, in group 15 and 16 with the exception of the elements of periods 2-5.

The metal impurities are measured using the following analytical method:

For the quantitative determination of the metal impurities (in particular Al, Ca, Cr, Cu, Fe, K, Mg, Mn, Na, Ni, Sn, Ti, and Zn, which can and often are present in amounts of more than 1 ppm by weight in the pristine material) in the sorbent material, inductively coupled plasma optical emission spectrometry (ICP-OES) is used. The measurements were performed using the Spectro Arcos FHM22 ICP-OES instrument (SPECTRO Analytical Instruments GmbH). The sample solution is introduced via a pneumatic atomizer system. At a temperature of 5000-7000 K in the plasma, the elements contained in the solution are atomized and excited to emit light. Since the atoms/ions emit electromagnetic radiation characteristic of the chemical element after excitation, the intensity of the light emitted at specific wavelengths is measured and used to determine the concentration of the element of interest. The concentrations in the sample are calculated using the measured intensities of the individual elements and using the functions of the recorded calibrations of the individual elements.

The calibration of the instrument is done in the following manner:

Merck's multi-element standard solutions for ICP (MISA-04-1, MISA-05-1, MISA-06-1) were used for preparing working standards. Deionized water acidified with HNO₃ (Merck) was used as the calibration blank.

The samples are prepared in the following manner:

Sorbent dissolution is achieved by microwave digestion. The sorbent is dried under N2 flow for 1 h at 94° C. and then cooled to room temperature. 0.5 g of sample is weighed and placed in a 100 ml sample holder. To the sample, 10 mL of 65% HNO₃ is added, and then the mixture is left to react for 10 min before the sample holder is closed. The sample holder is then placed in a microwave oven (StarT, MWS GmbH) until the sample has completely dissolved. The following temperature profile is used: heating to 240° C. at 3° C./min, holding for 1 h, followed by cooling down to 50° C. before removing the sample from the oven. The sample is then filtered with Whatman 42 (2.5 μm particle retention) filter paper. 2 mL of deionized water is used to wash the inner walls of the beaker to prevent the loss of the sample. Then, deionized water is added to make a final volume up to 50 mL.

The concentration of the metal impurities in the sorbent material is determined in the following manner: The concentrations in the sample are calculated using the measured intensities of the individual elements and using the functions of the recorded calibrations of the individual elements. The metal impurity concentration is expressed as the mean of three measurements. The concentration of the metal is expressed in mg metal per kg sorbent, so in ppm by weight.

The metals forming said metal impurity are typically selected from the group consisting of Al, Ca, Cr, Cu, Fe, K, Mg, Mn, Na, Ni, Sn, Ti, Zn, or a combination thereof. In most situations the metal impurities of concern are selected from the group consisting of Al, Ca, Fe, Mg, Mn, inter-alia because these metals are abundant and/or form part of catalysts and/or starting materials and/or treatments during synthesis, and/or are present in water used for treatment of the sorbent material.

According to yet another preferred embodiment, said treatment is selected from the group of acid-base wash, eluotropic row washing or treatment with a metal chelating agent, or a combination thereof.

Preferably, in case of acid-base wash said treatment involves at least one step of treatment with an aqueous solution at a pH of less than 5, preferably less than 3, most preferably less than 1, preferably in the form of an HCl, HNO₃, H₂SO₄, and/or CH₃COOH solution, as well as preferably also and followed by at least one step of treatment with an aqueous solution at a pH of more than 9, preferably more than 11, most preferably more than 13.5, preferably in the form of a solution of NaOH, Na₂CO₃, KOH, or a combination thereof. This base treatment step can be replaced and/or followed by washing with water to establish a pH in the range of 6-8, for example with water, preferably deionized water.

Preferably in case of eluotropic row washing said sorbent material is subjected to treatment with an alcoholic solvent liquid at room temperature, preferably selected from the group consisting of methanol, ethanol or (iso) propanol or a combination thereof, and/or, preferably followed by treatment with another polar organic solvent, preferably selected from acetone (or another ketone or acetate typically with less than 10 carbon atoms), methyl acetate or ethyl acetate or a combination thereof, preferably further followed by washing with a non-polar organic solvent, preferably an alkane, selected from the group consisting of propane, pentane, hexane, heptane, octane, decane, dodecane, in branched or linear forms, or a combination thereof.

Preferably in case of treatment with a metal chelating agent, said chelating agent is selected from the group of bidentate or polydentate chelating agents, preferably water-soluble chelating agents, preferably having primary and/or secondary amino, alcohol and/or ether groups for complexation with metal ions forming the metal impurity. The chelating agents are preferably selected from the group consisting of ethylenediamine and polymers thereof, oxalate, diethylenetriamine, triphosphate, ethylenediaminetetraaceticacid acid (EDTA), nitrilotriacetic acid (NTA), or a combination thereof.

These treatment methods can be combined and/or repeated, for example the acid-base wash can be carried out as a sequence of three alternating acid and base treatment steps, followed by neutral washing.

The sorbent material typically takes the form of sorbent particles, sorbent powder, a porous monolithic structure, or the form of an essentially contiguous adsorbent layer on a solid support carrier structure, or a combination thereof.

The amine moieties in the α-carbon position are preferably substituted by two hydrogen substituents or one hydrogen and one alkyl group (preferably having up to ten carbon atoms, preferably selected as methyl or ethyl) which can be linear or branched and can contain further amino moieties in the branching, or two alkyl groups (preferably having up to ten carbon atoms, preferably selected as methyl or ethyl) which can be linear or branched and can contain further amino moieties in the branching, or one hydrogen and an amino group, or one hydrogen and alkyl amino moieties where the alkyl group (up to ten carbon atoms, preferably methyl or ethyl) can be linear or branched and contain further amino moieties in the branching. preferably the sorbent material comprises primary and/or secondary benzylamine moieties. Most preferably the carbon dioxide capture moieties of the sorbent material consist of primary benzylamine moieties.

The solid support of the sorbent material can be a porous or non-porous material based on an organic and/or inorganic material, preferably a polymer material. Preferably this is selected from the group of linear or branched, cross-linked or uncross-linked polystyrene, polyethylene, polypropylene, polyamide, polyurethane, acrylate-based polymer including PMMA, polyacrylonitrile or combinations thereof, wherein preferably the polymer material is poly(styrene) or poly(styrene-co-divinylbenzene) based, cellulose, or an inorganic material including silica, alumina, activated carbon, metal organic frameworks, covalent organic frameworks, and combinations thereof.

Preferably, the sorbent material is based on a polystyrene material, preferably cross-linked polystyrene material and most preferably poly(styrene-co-divinylbenzene), which is at least partially functionalized with (primary or secondary) amino moieties or contains benzylamine moieties, preferably throughout the material or at least or only on its surface. The material or the functionalization can e.g. be obtained by amidomethylation or phthalimide or chloromethylation reaction pathways or a combination thereof.

The primary and/or secondary amine moieties can also be part of a polyethyleneimine structure, preferably obtained using aziridine, which is preferably chemically and/or physically attached to a solid support.

The sorbent material, preferably in porous form, and having specific BET surface area, in the range of 0.5-4000 m²/g or 1-2000, preferably 1-1000 m²/g, preferably takes the form of a monolith, the form of a layer or a plurality of layers, the form of hollow or solid fibres, including in woven or nonwoven (layer) structures, or the form of hollow or solid particles. The sorbent material according to yet another preferred embodiment takes the form of preferably essentially spherical beads with a particle size (D50) in the range of 0.002-4 mm, 0.005-2 mm, 0.002-1.5 mm, 0.005-1.6 mm or 0.01-1.5 mm, preferably in the range of 0.30-1.25 mm.

According to a second aspect of the present invention, it relates to a method for separating gaseous carbon dioxide from a gas mixture, preferably from at least one of ambient atmospheric air, flue gas and biogas, containing said gaseous carbon dioxide as well as further gases different from gaseous carbon dioxide, by cyclic adsorption/desorption using a sorbent material adsorbing said gaseous carbon dioxide in a unit.

The method comprises at least the following sequential and in this sequence repeating steps (a)-(e):
(a) contacting said gas mixture with the sorbent material to allow at least said gaseous carbon dioxide to adsorb on the sorbent material by flow-through through said unit under ambient atmospheric pressure conditions and ambient atmospheric temperature conditions in an adsorption step (if ambient atmospheric air is pushed through the device using a ventilator for the like, this is still considered ambient atmospheric pressure conditions in line with this application, even if the air which is pushed through the reactor by the ventilator has a pressure slightly above the surrounding ambient atmospheric pressure, and the pressures to is in the ranges as detailed above in the definition of “ambient atmospheric pressures”);
(b) isolating said sorbent material with adsorbed carbon dioxide in said unit from said flow-through, preferably while maintaining the temperature in the sorbent;
(c) inducing an increase of the temperature of the sorbent material, preferably to a temperature between 6° and 110° C., starting the desorption of CO₂ (this is e.g. possible by heat exchangers or by injecting a stream of saturated or superheated steam by flow-through through the unit and thereby inducing an increase of the temperature of the sorbent material to a temperature between 6° and 110° C., starting the desorption of CO₂);
(d) extracting at least the desorbed gaseous carbon dioxide from the unit and preferably separating gaseous carbon dioxide from steam, preferably by condensation, in or downstream of the unit;
(e) bringing the sorbent material to ambient atmospheric temperature conditions (if the sorbent material is not cooled in this step down to exactly the surrounding ambient atmospheric temperature conditions, this is still considered to be according to this step, preferably the ambient atmospheric temperature established in this step (e) is in the range of the surrounding ambient atmospheric temperature +25° C., preferably +10° C. or +5° C.). According to the invention, the sorbent material regenerated for use or used in such a repeating cycle comprises primary and/or secondary amine moieties immobilized on a solid support.

In the context of this disclosure, the expressions “ambient atmospheric pressure” and “ambient atmospheric temperature” refer to the pressure and temperature conditions to that a plant that is operated outdoors is exposed to, i.e. typically ambient atmospheric pressure stands for pressures in the range of 0.8 to 1.1 barabs and typically ambient atmospheric temperature refers to temperatures in the range of −40 to 60° C., more typically −30 to 45° C. The gas mixture used as input for the process is preferably ambient atmospheric air, i.e. air at ambient atmospheric pressure and at ambient atmospheric temperature, which normally implies a CO₂ concentration in the range of 0.03-0.06% by volume. However, also air with lower or higher CO₂ concentration can be used as input for the process, e.g. with a concentration of 0.1-0.5% by volume, so generally speaking, preferably the input CO₂ concentration of the input gas mixture is in the range of 0.01-0.5% by volume. However, also flue gas can be the source, in this case the input CO₂ concentration of the input gas mixture is typically in the range of up to 20% or up to 12% by volume, preferably in the range of 1-20% or 1-12% by volume.

In the above carbon dioxide capture method step sequence (a)-(e), in steps (a) and (e) reference is made to ambient atmospheric pressure conditions and ambient atmospheric temperature conditions. This only applies if the supplied gas mixture is provided under these conditions, for example in case of direct air capture, where the source of the gas mixture is atmospheric air. If, however the source of gas mixture is a different source, it may well be that the supply conditions are not ambient atmospheric pressure and/or are not ambient atmospheric temperature conditions. In particular, in case of flue gas the gas mixture can be and normally will be at an elevated temperature, for example at a temperature above room temperature, it may even be at a temperature above 50° C. The temperature may even go up to 70° C., and in that case normally the setup is adapted such that the temperature to desorb the carbon dioxide in step (c) is at least 10° C., preferably at least 20° C. higher than that temperature of the supply gas. So, under these non-atmospheric temperature and pressure conditions in step (a) and in step (e) normally the pressure and temperature conditions are different, specifically contacting in step (a) takes place under temperature and pressure conditions of the supplied gas mixture, and in step (e) the sorbent is brought to the temperature and pressure conditions of the supplied gas mixture.

According to the second aspect of the invention, in such a process either material prepared as described above is used as the sorbent material, or, after having repeated said sequence of steps (a)-(e) a number of times having led to deterioration of the sorbent material in the form of a reduced carbon dioxide capture capacity due to capping of the surface exposed amino groups with metal, the sorbent material is treated so as to have, after treatment, a total metal impurity content below 1400 ppm, preferably below 1200 ppm, more preferably below 1100 ppm, most preferably in the range of 200-1000 ppm, preferably using a method as described above.

Said unit is preferably evacuable to a vacuum pressure of 400 mbar (abs) or less, and step (b) may include isolating said sorbent with adsorbed carbon dioxide in said unit from said flow-through while maintaining the temperature in the sorbent and then evacuating said unit to a pressure in the range of 20-400 mbar (abs), wherein in step (c) injecting a stream of saturated or superheated steam is also inducing an increase in internal pressure of the reactor unit, and wherein step (e) includes bringing the sorbent material to ambient atmospheric pressure conditions and ambient atmospheric temperature conditions.

Preferably, after step (d) and before step (e) the following step is carried out:

(d1) ceasing the injection and, if used, circulation of steam, and evacuation of the unit to pressure values between 20-500 mbar (abs), preferably in the range of 50-250 mbar (abs) in the unit, thereby causing evaporation of water from the sorbent and both drying and cooling the sorbent.

Step (e) is preferably carried out exclusively by contacting said ambient atmospheric air with the sorbent material under ambient atmospheric pressure conditions and ambient atmospheric temperature conditions to evaporate and carry away water in the unit and to bring the sorbent material to ambient atmospheric temperature conditions.

After step (b) and before step (c) the following step can be carried out:

(b1) flushing the unit of non-condensable gases by a stream of non-condensable steam while essentially holding the pressure of step (b), preferably holding the pressure of step (b) in a window of ±50 mbar, preferably in a window of ±20 mbar and/or holding the temperature below 75° C. or 70° C. or below 60° C., preferably below 50° C.

In a further embodiment of the step b1, the temperature of the adsorber structure rises from the conditions of step (a) to 80-110° C. preferably in the range of 95-105° C.

In step (b1) the unit can preferably be flushed with saturated steam or steam overheated by at most 20° C. in a ratio of 1 kg/h to 10 kg/h of steam per liter volume of the adsorber structure, while remaining at the pressure of step (b1), to purge the reactor of remaining gas mixture/ambient air. The purpose of removing this portion of ambient air is to improve the purity of the captured CO₂.

In step (c), steam can be injected in the form of steam introduced by way of a corresponding inlet of said unit, and steam can be (partly or completely) recirculated from an outlet of said unit to said inlet, preferably involving reheating of recirculated steam, or by the re-use of steam from a different reactor.

It should be noted that heating for desorption according to this process in step (c) is preferably only affected by this steam injection and there is no additional external or internal heating e.g. by way of tubing with a heat fluid.

In step (c) furthermore preferably the sorbent can be heated to a temperature in the range of 80-110° C. or 80-100° C., preferably to a temperature in the range of 85-98° C.

According to yet another preferred embodiment, in step (c) the pressure in the unit is in the range of 700-950 mbar (abs), preferably in the range of 750-900 mbar (abs).

According to a first preferred embodiment of the second aspect of the invention, treatment to reduce the total metal impurity content is carried out in situ in the device for separating gaseous carbon dioxide from a gas mixture, preferably by acid-base wash, eluotropic row washing or treatment with a metal chelating agent, or a combination thereof. In fact, it can be carried out in situ using any of the schemes as described in the context of the above method for preparing sorbent material for use as adsorbent for carbon dioxide separation from a gas mixture.

Alternatively, the second aspect of the invention can be implemented in that the treatment is carried out by taking the sorbent material out of the device for separating gaseous carbon dioxide from a gas mixture, the sorbent material is treated to reduce the total metal impurity content, and then reintroduced into the device for separating gaseous carbon dioxide to continue the separation process.

Treatment of the sorbent material is typically carried out if the carbon dioxide capture capacity has dropped by more than 30%, preferably by more than 20%, more preferably by more than 15% compared with the carbon dioxide capture capacity of pristine sorbent material.

Treatment of the sorbent material can also be carried out after having cycled the sequence of steps at least 500 times, preferably at least 1000 times, more preferably at least 10,000 times, but preferably before having cycled the sequence of steps 50,000 times, preferably before having cycled the sequence of steps 25,000 times.

The time point for refreshing the material can be dynamically chosen either as a function of the observed carbon dioxide capture capacity as detected by corresponding sensors, or it can be calculated and/or dynamically adapted as a function of the metal impurity content measured in the sorbent, or it can be calculated and/or dynamically adapted as a function of the metal content in water and/or vapour and/or steam used in the carbon dioxide capture process.

According to a third aspect of the present invention it relates to a use of a material produced as described above for separating gaseous carbon dioxide from a gas mixture, preferably from at least one of ambient atmospheric air, flue gas and biogas, containing said gaseous carbon dioxide as well as further gases different from gaseous carbon dioxide, by cyclic adsorption/desorption using a sorbent material adsorbing said gaseous carbon dioxide in a unit.

According to a fourth aspect of the present invention, it relates to a sorbent material for use as adsorbent for carbon dioxide separation from a gas mixture, which has a total metal impurity content below 1400 ppm, preferably below 1200 ppm, more preferably below 1100 ppm, most preferably in the range of 200-1000 ppm, preferably prepared using a method as described above. The sorbent preferably but not necessarily is one comprising primary amine or secondary amine moieties, or a combination thereof, immobilised on a solid support.

Further embodiments of the invention are laid down in the dependent claims.

### BRIEF DESCRIPTION OF THE DRAWINGS

Preferred embodiments of the invention are described in the following with reference to the drawings, which are for the purpose of illustrating the present preferred embodiments of the invention and not for the purpose of limiting the same. In the drawings,

FIG. 1 shows the correlation between the CO₂ capture capacity and the metal content, i.e. the effect of metal impurity (Al, Ca, Cr, Cu, Fe, K, Mg, Mn, Na, Ni, Ti, Zn) content on the CO₂ capture capacity of sorbents under DAC conditions;

FIG. 2 shows the effect of different treatments (acid-base wash, eluotropic row wash, EDTA wash, three consecutive acid-base washes) on the CO₂ capacity of the sorbent under DAC conditions;

FIG. 3 shows the behaviour of the CO₂ capture capacity as a function of aging for sorbent with high impurity and with low impurity;

FIG. 4 shows the rig measuring the CO₂ capture capacity;

FIG. 5 shows the effect of deionised for demineralized liquid water and steam treatments on the CO₂ capacity of the sorbent under DAC conditions

FIG. 6 shows the correlation between the CO₂ capture capacity and the metal content, i.e. the effect of metal impurity (Al, Ca, Cr, Cu, Fe, K, Mg, Mn, Na, Ni, Ti, Zn) content on the CO₂ capture capacity of sorbents under DAC conditions including the samples having been subjected to deionised/demineralized liquid water and steam treatments as also given in FIG. 5.

### DESCRIPTION OF PREFERRED EMBODIMENTS

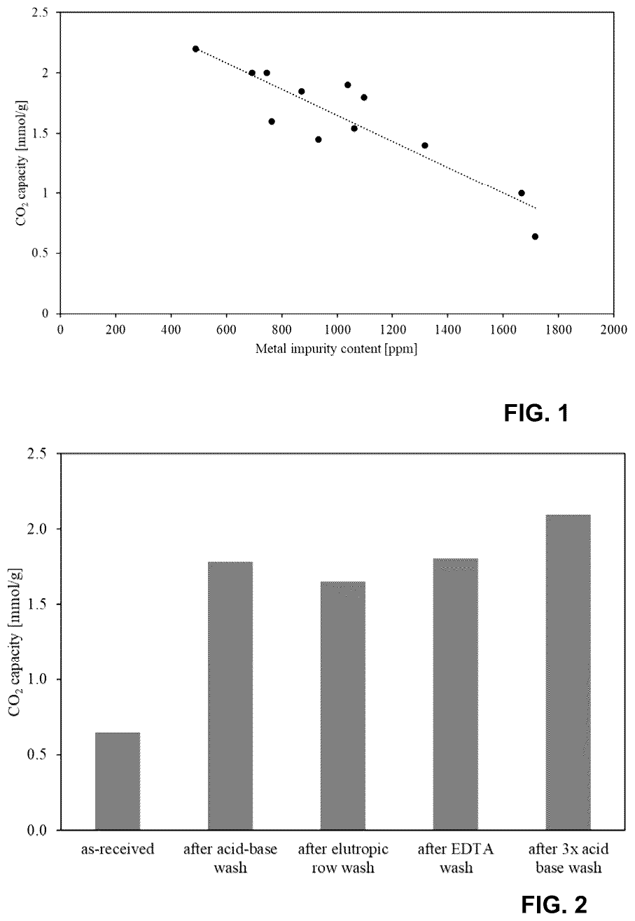

In the following working examples cross-linked polystyrene beads (essentially spherical beads with a particle size (D50) in the range of 0.30-1.2 mm) functionalized with benzylamine units were used. The untreated material used (designated as “as-received”) has a metal content of 1715 ppm (by weight) as determined using ICP-OES taking as the sum of the metal impurity content the contents of Al, Ca, Cr, Cu, Fe, K, Mg, Mn, Na, Ni, Sn, Ti, and Zn. Using the carbon dioxide capacity measurement setup as described further below, this material had a carbon dioxide capacity of 0.65 mmol/g (see also FIG. 1 and FIG. 2).

The elemental analysis of the untreated material is as follows (Element Content/wt. %): C=78.6; H=8.3; N=11.0:

Synthesis Procedure of Styrene-Divinylbenzene Resin Functionalized with Benzylamine Units

In a 1 L reactor, 1% (mass ratio) of gelatin and 2% (mass ratio) of sodium chloride are dissolved in 340 ml of water at 45° C. for 1 h. In another flask, 1 g of benzoyl peroxide is dissolved in a mixture of 57.8 g of styrene, 5.86 g of divinylbenzene (content 80%) and 63.84 g of C11-C13 iso-paraffin. The resulting mixture is then added to the reactor. After that the reaction mixture is stirred and heated up to 70° C. maintaining the temperature for 2 h, then the temperature is raised to 80° C. and kept it for 3 h, and then raised to 90° C. for 6 h. The reaction mixture is cooled down to room temperature and the beads are filtered off using a funnel glass filter and vacuum suction. The beads are washed with toluene and dried in rotavapor.

The polystyrene-divinylbenzene beads are functionalized using the chloromethylation reaction. 5 g of so obtained beads are added to a 3-neck flask containing 50 ml of chloromethyl methyl ether. The mixture is stirred for 1 h, 2 g of zinc chloride is added and is heated to 40° C. and kept it for 24 h. After that, the beads are filtered off and wash with 25% HCl and water to obtain chloromethylated beads. To obtain benzylamine units, the chloromethylated beads are aminated using the following procedure. The chloromethylated beads are added to a three-necked flask with 27 g of methylal and the mixture is stirred for 1 h. To this mixture, 16 g of hexamethylenetetramine and 13 g of water are added and kept under gentle reflux for 24 h. The beads are filtered off and washed with water. To have a primary amine, a hydrolysis step followed by a treatment with a bases are required. The beads are placed in a 3-neck flask containing 140 mL of a solution of hydrochloric acid (30%)-ethanol (95%) (volume ratio of 1:3), the reaction mixture is heated to 80° C. and kept at this temperature for 20 h. After that, the beads are filtered off and washed with water. At this stage the amine is protonated and to free the base, the beads are treated with 50 mL of an NaOH solution 2 M, and stirred with 1 h at 80° C. The aminated beads are filter off and washed to neutral pH with demineralized water.

### Procedure Acid Base Wash

6 g of styrene-divinylbenzene resin functionalized with benzylamine units (material as-received) are placed in a 250 ml beaker. 60 mL of a 0.5 M HCl solution is added to the sorbent and left under stirring for 24 h at 35° C. The suspension is filtered off and washed with deionized water until pH 7. After that, 60 mL of a 0.5 M NaOH solution is added to the sorbent in a 250 ml beaker. The sorbent is left to react under stirring for 15 min at 35° C. The sorbent is filtered off and washed with deionized water until pH 7.

The resulting acid-base washed material had a metal content of 637 ppm (by weight) as determined using ICP-OES.

Using the carbon dioxide capacity measurement setup as described further below, this material had a carbon dioxide capacity of 1.78 mmol/g (see FIG. 2).

### Procedure Eluotropic Row

6 g of styrene-divinylbenzene resin functionalized with benzylamine units (material as-received) are placed in a chromatography column with a frit at the bottom. 60 mL of methanol is put in the column and let passing through the resin by gravity. Once there is no more methanol, 60 mL of acetone is added. When no more acetone is present in the bed, 60 mL of n-heptane is added. After that, the sorbent is spread out in a petri dish. The petri dish is put in the vacuum oven at 40° C. keeping a pressure between 300 and 400 mbar for 24 h.

The resulting eluotropic row washed material had a metal content of 772 ppm (by weight) as determined using ICP-OES.

Using the carbon dioxide capacity measurement setup as described further below, this material had a carbon dioxide capacity of 1.65 mmol/g (see FIG. 2).

Procedure with EDTA

6 g of styrene-divinylbenzene resin functionalized with benzylamine units (material as-received) are placed in a 250 ml beaker. 60 mL of a 1.0 M EDTA in a 0.44 M NaOH solution is added to the sorbent and left under stirring for 24 h at 35° C. The suspension is filtered off and washed with deionized water until pH 7. After that, 60 mL of a 0.5 M NaOH solution is added to the sorbent in a 250 ml beaker. The sorbent is left to react under stirring for 15 min at 35° C. The sorbent is filtered off and washed with deionized water until pH 7.

The resulting acid-base washed material had a metal content of 762 ppm (by weight) as determined using ICP-OES.

Using the carbon dioxide capacity measurement setup as described further below, this material had a carbon dioxide capacity of 1.80 mmol/g (see FIG. 2).

### Procedure Triple Acid Base Wash

6 g of styrene-divinylbenzene resin functionalized with benzylamine units (material as-received) are placed in a 250 ml beaker. 60 mL of a 0.5 M HCl solution is added to the sorbent and left under stirring for 24 h at 35° C. The suspension is filtered off and washed with deionized water until pH 7. This acid wash step is repeated two more times, so that the material is washed three times in total. After that, 60 mL of a 0.5 M NaOH solution is added to the sorbent in a 250 ml beaker. The sorbent is left to react under stirring for 15 min at 35° C. The sorbent is filtered off and washed with deionized water until pH 7.

The resulting acid-base washed material had a metal content of 914 ppm (by weight) as determined using ICP-OES.

Using the carbon dioxide capacity measurement setup as described further below, this material had a carbon dioxide capacity of 2.10 mmol/g (see FIG. 2).

### Water Washing and Steam Treatment Comparison Test

Water washing: 15 g of untreated styrene-divinylbenzene resin functionalized with benzylamine units (material as-received) was added to a 150 ml beaker containing a stirring bar. Deionized water (150 mL) was added to the beaker and stirring was started and kept at 250 rpm. After 3 h, stirring was stopped, the sorbent filtered using a vacuum pump and air-dried for 24 h at 25° C. in a petri dish to a solid content of approximately 80 w/w %. The resulting liquid water washed material had a metal content of 1560 ppm (by weight) as determined using ICP-OES (see FIG. 6).

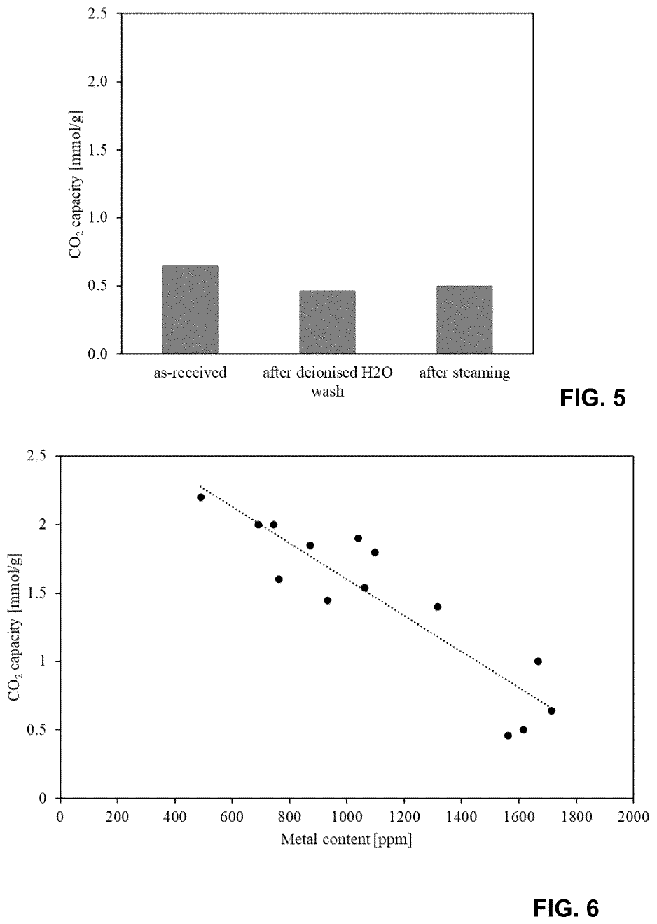

Using the carbon dioxide capacity measurement setup as described further below, this material had a carbon dioxide capacity of 0.46 mmol/g (see FIG. 5).

Steam treatment: 15 g of untreated styrene-divinylbenzene resin functionalized with benzylamine units (material as-received) was added into a closed reactor. Air (450 ppm CO2, 60% RH) was passed through the reactor for 1 h. Vacuum was pulled down to 200 mbar and the sample was heated up with a steam flow of 10 mL/min up to 95° C. (900 mbar) and kept at this temperature for 10 min. The sample was cooled down again by pulling vacuum and removing the steam system to reach a temperature of 18° C. This cycle was repeated three times.

The resulting steam treated material had a metal content of 1620 ppm (by weight) as determined using ICP-OES (see FIG. 6).

Using the carbon dioxide capacity measurement setup as described further below, this material had a carbon dioxide capacity of 0.50 mmol/g (see FIG. 5).

As one can see from the figures, neither the deionized/demineralized liquid water treatment nor the steam treatment, which equals the steam treatment in a DAC adsorption/desorption process, has an influence on the metal impurity content nor on the capture capacity in the sense of a treatment according to the invention, and it does by far not lead to a metal impurity content as claimed.

### Degradation Test

To assess the degradation rate of sorbent materials, sorbents are oxidized under an air flow at ca 90° C. This test gives indications on how much the sorbent oxidize over time. Two sample, one with high metal content (2872 ppm) and one with low metal content (514 ppm) were used for the experiment. The test is conducted using the following procedure: 60 g of sorbent is loaded in a reactor and 100 mL/min of synthetic air is sent through the sorbent bed at 90° C. After 4 days of exposure, a sample of was taken out of the reactor and tested in a CO₂ adsorption/desorption device. The adsorption experiment was conducted by filling 6 g of dry sample into a cylinder with an inner diameter of 40 mm and a height of 40 mm and placed into a CO₂ adsorption/desorption device, where it was exposed to a flow of 2.0 NL/min of air at 30° C. containing 450 ppmv CO₂, having a relative humidity of 60% corresponding to a temperature of 30° C. for a duration of 600 min. Prior to adsorption, the sorbent bed was desorbed by heating the sorbent to 94° C. under an air and/or nitrogen flow of 2.0 NL/min

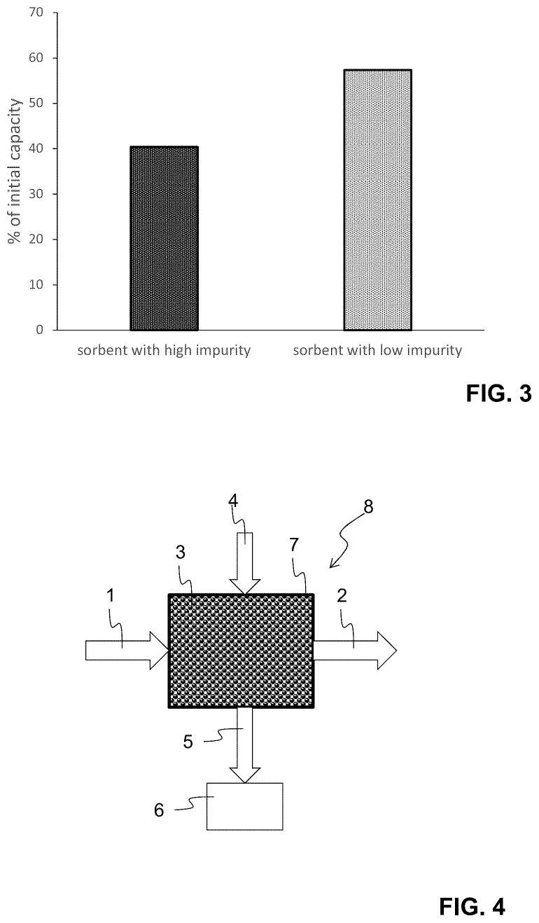

The adsorption capacity of the oxidized sample is compared against the capacity of the sample prior to the exposure to synthetic air at high temperature. As one can see in FIG. 3, the percentage of retained capacity compared to the untreated sorbent is much higher for the sample with the low metal content than the sample with high impurities level (2872 ppm), 57% vs 40%, respectively. This is rationalized on the basis that transition metals are known to catalyze oxidation reactions via multiple mechanisms. Thus, it is of critical importance as shown in FIG. 3 to keep the impurity level as low as possible since it has a tremendous effect on the degradation of the sorbent and consequently on the carbon capture economy.

### Carbon Dioxide Capture Capacity Properties:

The beads according to the above examples were tested in an experimental rig in which the beads were contained in a packed-bed reactor or in air permeable layers. The rig is schematically illustrated in FIG. 4. There is an ambient air inflow structure 1 and the actual reactor unit 8 comprises a container or wall 7 within which the layers of sorbent material 3 are located. There is an inflow structure 4 for desorption, if for example steam is used for desorption, and there is a reactor outlet 5 for extraction. Further, there is a vacuum unit 6 for evacuating the reactor.

For the adsorption measurements, 6 g of dry sample was filled into a cylinder with an inner diameter of 40 mm and a height of 40 mm and placed into a CO₂ adsorption/desorption device, where it was exposed to a flow of 2.0 NL/min of air at 30° C. containing 450 ppmv CO₂, having a relative humidity of 60% corresponding to a temperature of 30° C. for a duration of 600 min. Prior to adsorption, the sorbent bed was desorbed by heating the sorbent to 94° C. under an air flow of 2.0 NL/min. The amount of CO₂ adsorbed on the sorbent was determined by integration of the signal of an infrared sensor measuring the CO₂ content of the air stream leaving the cylinder.

The adsorber structure can alternatively be operated using a temperature/vacuum swing direct air capture process involving temperatures up to and vacuum pressures in the range of 50-250 mbar (abs) and heating the sorbent to a temperature between 6° and 110° C. In addition, experiments involving steam were carried out, with or without vacuum.

### Results and Interpretation:

As one can see from the graphical representation given in FIG. 2, for each of these metal purification methods one obtains significantly increased carbon dioxide capacity values compared with the as-received material, in each case by more than a factor of two higher than of the untreated material. One can also see that repetitive treatment with one method or also using different methods consecutively provides for an even higher carbon dioxide capacity.

Furthermore, as one can see from FIG. 1, correlating the metal impurity content in ppm (by weight) in the sorbent material with the carbon dioxide capacity, unexpectedly there is an almost linear correlation between the metal impurity content and the carbon dioxide capacity. Untreated material typically has a metal impurity content in the range of at least 1600 ppm, reducing that metal impurity content to below 1400 ppm, preferably to below 1200 ppm, most preferably below 1000 ppm, significantly increases the carbon dioxide capacity.

As one can see from FIG. 6, which in addition includes the data for the two samples having been subjected to deionized/demineralized liquid water treatment and steam treatment, this kind of exposure of the sorbent material does not lead to low metal contents.

LIST OF REFERENCE SIGNS

| | |
|---|---|
| 1 | ambient air, ambient air inflow structure |
| 2 | outflow of ambient air behind adsorption unit in adsorption |
| | flow-through mode |
| 3 | sorbent material |
| 4 | steam, steam inflow structure for desorption |
| 5 | reactor outlet for extraction |
| 6 | vacuum unit/separator |
| 7 | wall |
| 8 | reactor unit |

1. A method for the preparation of sorbent material for use as adsorbent for carbon dioxide separation from a gas mixture,
said sorbent material comprising primary amine or secondary amine moieties, or a combination thereof, immobilised on a solid support,
wherein said sorbent material comprising primary amine or secondary amine moieties, or a combination thereof, is treated so as to have, after treatment, a total metal impurity content below 1400 ppm.

2. The method according to claim 1, wherein said sorbent material, after treatment, has a total metal impurity content below 1200 ppm.

3. The method according to claim 1, wherein the metals forming said metal impurity are selected from the group consisting of Al, Ca, Cr, Cu, Fe, K, Mg, Mn, Na, Ni, Sn, Ti, Zn, or a combination thereof.

4. The method according to claim 1, wherein said treatment is selected from the group of acid-base wash, cluotropic row washing or treatment with a metal chelating agent, or a combination thereof.

5. The method according to claim 1, wherein the sorbent material takes the form of sorbent particles, sorbent powder, a porous monolithic structure, or the form of an essentially contiguous adsorbent layer on a solid support carrier structure, or a combination thereof.

6. The method according to claim 1, wherein the amine moieties in the α-carbon position are substituted by hydrogen and/or alkyl.

7. The method according to claim 1, wherein the solid support of the sorbent material is a porous or non-porous material based on an organic and/or inorganic material.

8. The method according to claim 1, wherein the primary and/or secondary amine moieties are part of a polyethyleneimine structure.

9. The method according to claim 1, wherein the sorbent material, takes the form of a monolith, the form of a layer or a plurality of layers, the form of hollow or solid fibres, including in woven or nonwoven (layer) structures, or the form of hollow or solid particles.

10. The method according to claim 1, wherein the sorbent material takes the form of beads with a particle size (D50) in the range of 0.002-4 mm.

11. A method for separating gaseous carbon dioxide from a gas mixture, including from at least one of ambient atmospheric air, flue gas and biogas, containing said gaseous carbon dioxide as well as further gases different from gaseous carbon dioxide, by cyclic adsorption/desorption using a sorbent material adsorbing said gaseous carbon dioxide in a unit,
wherein the method comprises at least the following sequential and in this sequence repeating steps (a)-(e):
(a) contacting said gas mixture with the sorbent material to allow at least said gaseous carbon dioxide to adsorb on the sorbent material by flow-through through said unit, in case of ambient atmospheric air as gas mixture under ambient atmospheric pressure conditions and ambient atmospheric temperature conditions and in other cases under temperature and pressure conditions of the supplied gas mixture, in an adsorption step;
(b) isolating said sorbent material with adsorbed carbon dioxide in said unit from said flow-through;
(c) inducing an increase of the temperature of the sorbent material to a temperature starting the desorption of CO₂, inducing an increase of the temperature of the sorbent material to a temperature between 6° and 110° C., starting the desorption of CO₂;
(d) extracting at least the desorbed gaseous carbon dioxide from the unit and separating gaseous carbon dioxide from steam in or downstream of the unit;
(e) bringing the sorbent material, in case of ambient atmospheric air as gas mixture, to ambient atmospheric temperature conditions, and in other cases to the temperature and pressure conditions of the supplied gas mixture;
wherein said sorbent material comprises primary and/or secondary amine moieties or a combination thereof immobilized on a solid support,
and wherein
either material prepared according to claim 1 is used as the sorbent material,
or, after having repeated said sequence of steps a number of times having led to deterioration of the sorbent material in the form of a reduced carbon dioxide capture capacity, the sorbent material is treated so as to have, after treatment, a total metal impurity content below 1400 ppm.

12. The method according to claim 11, wherein treatment to reduce the total metal impurity content is carried out in situ in the device for separating gaseous carbon dioxide from a gas mixture, or is carried out by taking the sorbent material/support material out of the device for separating gaseous carbon dioxide from a gas mixture, is treated to reduce the total metal impurity content, and then reintroduced into the device for separating gaseous carbon dioxide to continue the separation process.

13. The method according to claim 11, wherein treatment of the sorbent material is carried out if the carbon dioxide capture capacity has dropped by more than 30%, compared with the carbon dioxide capture capacity of pristine sorbent material,
or wherein treatment of the sorbent material is carried out after having cycled the sequence of steps at least 500 times.

14. Method of use of a material produced or treated according to claim 1 for separating gaseous carbon dioxide from a gas mixture, including from at least one of ambient atmospheric air, flue gas and biogas, containing said gaseous carbon dioxide as well as further gases different from gaseous carbon dioxide, by cyclic adsorption/desorption using a sorbent material adsorbing said gaseous carbon dioxide in a unit.

15. A sorbent material for use as adsorbent for carbon dioxide separation from a gas mixture, which has a total metal impurity content below 1400 ppm.

16. The method according to claim 1, wherein said sorbent material, after treatment, has a total metal impurity content below 1100 ppm, or in the range of 200-1000 ppm.

17. The method according to claim 1, wherein the metals forming said metal impurity are selected from the group consisting of Al, Ca, Fe, Mg, Mn or a combination thereof.

18. The method according to claim 1, wherein said treatment is selected from the group of acid-base wash, eluotropic row washing or treatment with a metal chelating agent, or a combination thereof,
wherein in case of acid-base wash said treatment involves at least one step of treatment with an aqueous solution at a pH of less than 5 or less than 3, or less than 2 or less than 1, or less than 0.5, including in the form of a solution of HCl, HNO₃, H₂SO₄, CH₃COOH, or a combination thereof, as well as at least one step of treatment with an aqueous solution at a pH of more than 9 or more than 10 or more than 11, or more than 13, or more than 13.5, including in the form of a solution of NaOH, Na₂CO₃, KOH, or a combination thereof, followed by washing with water to establish a pH in the range of 6-8,
wherein in case of eluotropic row washing said sorbent material is subjected to treatment with an alcohol, including selected from the group consisting of methanol, ethanol or (iso) propanol or a combination thereof, and/or with another polar organic solvent, including selected from acetone, methyl acetate or ethyl acetate or a combination thereof, followed by washing with a non-polar organic solvent, including an alkane, selected from the group consisting of propane, pentane, hexane, heptane, octane, decane, dodecane, in branched or linear forms, or a combination thereof,
wherein in case of treatment with a metal chelating agent, said chelating agent is selected from the group of bidentate or polydentate chelating agents, including water soluble chelating agents, including having primary and/or secondary amino, alcohol and/or ether groups for complexation with metal ions forming the metal impurity, including those selected from the group consisting of ethylenediamine and polymers thereof, oxalate, diethylenetriamine, triphosphate, ethylenediaminetetraaceticacid acid (EDTA), nitrilotriacetic acid (NTA), or a combination thereof.

19. The method according to claim 1, wherein the amine moieties in the α-carbon position are substituted by one methyl and one hydrogen substituent or by two hydrogen substituents, wherein the sorbent material comprises primary and/or secondary benzylamine moieties,
or wherein the carbon dioxide capture moieties of the sorbent material consist of primary benzylamine moieties.

20. The method according to claim 1, wherein the solid support of the sorbent material is a porous or non-porous material based on a polymer material, selected from the group of linear or branched, cross-linked or uncross-linked polystyrene, polyethylene, polypropylene, polyamide, polyurethane, acrylate-based polymer including PMMA, polyacrylonitrile or combinations thereof, including poly(styrene) or poly(styrene-co-divinylbenzene) based, cellulose, or an inorganic material including silica, alumina, activated carbon, metal organic frameworks, covalent organic frameworks, and combinations thereof,
or wherein the sorbent material is based on a polystyrene material, including cross-linked polystyrene material and poly(styrene-co-divinylbenzene), which is at least partially functionalized with amino moieties or contains benzylamine moieties, throughout the material or at least or only on its surface, wherein the material or the functionalization can be obtained by amidomethylation or phthalimide or chloromethylation reaction pathways or a combination thereof.

21. The method according to claim 1, wherein the primary and/or secondary amine moieties are part of a polyethyleneimine structure, obtained using aziridine, which is chemically and/or physically attached to a solid support.

22. The method according to claim 1, wherein the sorbent material, in porous form, and having specific BET surface area, in the range of 0.5-4000 m2/g or 1-2000, or 1-1000 m2/g, takes the form of a monolith, the form of a layer or a plurality of layers, the form of hollow or solid fibres, including in woven or nonwoven (layer) structures, or the form of hollow or solid particles.

23. The method according to claim 1, wherein the sorbent material takes the form of essentially spherical beads with a particle size (D50) in the range of 0.005-2 mm, 0.002-1.5 mm, 0.005-1.6 mm or 0.01-1.5 mm, or in the range of 0.30-1.25 mm.

24. The method according to claim 11, wherein the sorbent material is treated so as to have, after treatment, a total metal impurity content below 1200 ppm, or below 1100 ppm, or in the range of 200-1000 ppm, using a method according to claim 1.

25. The method according to claim 11, wherein treatment to reduce the total metal impurity content is carried out in situ in the device for separating gaseous carbon dioxide from a gas mixture, by acid-base wash, eluotropic row washing or treatment with a metal chelating agent, or a combination thereof, or is carried out by taking the sorbent material/support material out of the device for separating gaseous carbon dioxide from a gas mixture, is treated by acid-base wash, eluotropic row washing or treatment with a metal chelating agent to reduce the total metal impurity content, and then reintroduced into the device for separating gaseous carbon dioxide to continue the separation process.

26. The method according to claim 11, wherein treatment of the sorbent material is carried out if the carbon dioxide capture capacity has dropped by more than 20%, or by more than 15% compared with the carbon dioxide capture capacity of pristine sorbent material,
or wherein treatment of the sorbent material is carried out after having cycled the sequence of steps at least 1000 times, or at least 10,000 times, and/or before having cycled the sequence of steps 50,000 times, or before having cycled the sequence of steps 25,000 times.

27. The sorbent material according to claim 15, which has a total metal impurity content below 1200 ppm, or below 1100 ppm, or in the range of 200-1000 ppm, prepared or treated using a method according to claim 1.
